(19) United States
(12) Patent Application Publication
(10) Pub. No.: US 2007/0131180 A1
(43) Pub. Date: Jun. 14, 2007

(54) Water and/or alcohol water secondary injection system for diesel engines

(75) Inventor: Charles Roehm, Naperville, IL (US)

Correspondence Address: HARRY M. LEVY;OLSON & HIERL, LTD., 20 North Wacker, 36th Floor, CHICAGO, IL, 60606-4401, US

(73) Assignee: The University of Chicago, Chicago, IL (US)

(21) Appl. No.: 11/353,286

(22) Filed: Feb. 9, 2006

Related U.S. Application Data
(60) Provisional application No. 60/749,743, filed on Dec. 13, 2005.

(51) Int. Cl. F02B 47/02; F02M 25/00; F02B 43/00; F02B 13/00

(52) U.S. Cl. 123/25 A; 123/304; 123/575; 123/1 A; 123/25 E

(57) ABSTRACT

A system for reducing the emissions of the oxides of nitrogen(NOx) and improving the fuel efficiency of a diesel engine having at least one combustion chamber and a camshaft and a crankshaft and an intake port and an operator controlled throttle with at least one electronically actuated diesel fuel injector; a diesel fuel supply reservoir communicatively connected with the diesel fuel injector and including diesel fuel pumping means for maintaining diesel fuel pressure at the inlet of the diesel fuel injector; at least one electronically actuated water and/or alcohol injector; a water and/or alcohol supply reservoir communicatively connected with the water and/or alcohol injector and including water and/or alcohol pumping means for maintaining liquid pressure at the inlet of the water and/or alcohol injector; and an electronic regulating means for controlling the rate at which atomized diesel fuel and water and/or alcohol are independently injected respectively into the combustion chamber and intake port. The electronic regulating means is being operatively connected to the injectors and is responsive to one or more of air temperature in the air intake manifold, the position of the throttle, the intake manifold pressure, the camshaft position, the crankshaft position, the engine rotational speed wherein the amount of water and/or alcohol injected into the intake port is controlled as a function of both the amount of diesel fuel and alcohol injected and the ratio of diesel fuel and alcohol to air in the combustion fuel mixture to reduce NOx emissions and improve fuel efficiency over the operating range of the diesel engine.

### RELATED APPLICATION

This application, pursuant to 37 C.F.R. 1.78(c), claims priority based on U.S. Provisional Application Ser. No. 60/749,743 Filed Dec. 13, 2005

### CONTRACTUAL ORIGIN OF THE INVENTION

The United States Government has rights in this invention pursuant to Contract No. W-31-109-ENG-38 between the U.S. Department of Energy and The University of Chicago representing Argonne National Laboratory.

### FIELD OF THE INVENTION

This invention relates to a system for reducing the discharge of emissions from diesel engines while enhancing diesel fuel efficiency. More specifically this invention relates to a means to provide a water and/or alcohol/water secondary injection system for diesel engines for reducing engine-out emissions while maintaining acceptable fuel economy, engine performance and engine durability.

### BACKGROUND OF THE INVENTION

Diesel engines typically have high exhaust emissions, such as particulates and nitrogen oxides (NOₓ). EPA emissions standards for future truck, stationary, marine and diesel locomotive engines require simultaneous reduction of NOₓ and total particulate levels while maintaining a goal of not sacrificing fuel efficiency or performance. The reduction of total particulate emissions while meeting NOₓ emission standards has been an ongoing challenge. One current research approach is in the direction of using large amounts of exhaust gas recirculation (EGR), in excess of 30 percent, and probably cooled EGR in conjunction with substantial exhaust gas aftertreatment. The principle purpose of EGR is to reduce the temperature of combustion thereby reducing the formation of NOₓ, which is primarily temperature dependent. The primary constituent of EGR that causes this to happen is the contained water vapor. However, the use of large amounts of EGR reduces fuel efficiency and may increase the particulates in the exhaust gases being emitted from the engine because the recirculated gases contain soot particles. Furthermore, the EGR gas is corrosive and can compromise engine durability and reliability.

The two primary methods used for introducing EGR to the engine include directly into the intake manifold plenum, and, by a distributive system to the individual intake ports. It is difficult to achieve good distribution of EGR, when injected into the manifold plenum since, since cylinders closer to the point of injection will receive higher flow rates. Distribution to the individual intake ports requires a much more complex and hence expensive distribution system. Both systems are of the constant flow variety and are difficult to precisely control. Cooled EGR would require a cooler and the associated plumbing required to be added to the system thus further increasing the system's cost.

This invention negates the need for an EGR system as a means of controlling engine-out NOₓ emissions, provides a means of substitution of a portion of the diesel fuel consumed by the engine with an alcohol, and, addresses the above objectives without the compromising performance and/or fuel efficiency limitations of EGR and several other approaches.

### SUMMARY OF THE INVENTION

Accordingly, it is an important object of the present invention to provide a system for reducing the emissions of the oxides of nitrogen(NOₓ) and improving the fuel efficiency of a diesel engine having at least one combustion chamber and a camshaft and a crankshaft and an intake port and an operator controlled throttle comprising at least one electronically actuated diesel fuel injector; a diesel fuel supply reservoir communicatively connected with the diesel fuel injector and including diesel fuel pumping means for maintaining diesel fuel pressure at the inlet of the diesel fuel injector; at least one electronically actuated water and/or alcohol injector; a water and/or alcohol supply reservoir communicatively connected with the water and/or alcohol injector and including water and/or alcohol pumping means for maintaining liquid pressure at the inlet of the water and/or alcohol injector; and a electronic regulating means for controlling the rate at which atomized diesel fuel and water and/or alcohol are independently injected respectively into the combustion chamber and intake port, the means being operatively connected to the injectors and being responsive to one or more of air temperature in the air intake manifold, the position of the throttle, the intake manifold pressure, the camshaft position, the crankshaft position, engine rotational speed wherein the amount of water and/or alcohol injected into the intake port is controlled as a function of both the amount of diesel fuel and alcohol injected and the ratio of diesel fuel and alcohol to air in the combustion fuel mixture to reduce NOₓ emissions and improve fuel efficiency over the operating range of the diesel engine.

A further object of the present invention is to provide a method for reducing the emissions of the oxides of nitrogen(NOₓ) and improving the fuel efficiency of a diesel engine having at least one combustion chamber and a camshaft and a crankshaft and an intake port and an operator controlled throttle comprising providing at least one electronically actuated diesel fuel injector; providing a diesel fuel supply reservoir communicatively connected with the diesel fuel injector and including diesel fuel pumping means for maintaining diesel fuel pressure at the inlet of the diesel fuel injector; providing at least one electronically actuated water and/or alcohol injector; providing a water and/or alcohol supply reservoir communicatively connected with the water and/or alcohol injector and including water and/or alcohol pumping means for maintaining liquid pressure at the inlet of the water and/or alcohol injector; and providing electronic regulating means for controlling the rate at which atomized diesel fuel and water and/or alcohol are independently respectively injected into the combustion chamber and intake port and operatively connected to the injectors and being responsive to one or more of air temperature in the air intake manifold, the position of the throttle, the intake manifold pressure, the camshaft position, the crankshaft position, engine rotational speed wherein the amount of water and/or alcohol injected into the intake port is controlled as a function of both the amount of diesel fuel and alcohol injected and the ratio of diesel fuel and alcohol to air in the combustion fuel mixture to reduce NOₓ emissions and improve fuel efficiency over the operating range of the diesel engine.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a graphical representation of a diesel engine configured according to the subject invention;

FIG. 2 is a schematic representation of the test methodology used in testing the present invention;

FIG. 3 is a graphical presentation of test results showing the variation of NOₓproduction as a percent of water with respect to diesel fuel injected by volume;

FIGS. 4-10 are graphical representations similar to FIG. 3 showing the relationships between various parameters and products from the use of the diesel engine. Each figure is clearly labeled as to what is being tested.

### DETAILED DESCRIPTION OF THE INVENTION

The injection of water or ethanol/water into the engine combustion chamber provides the water vapor equivalent of varying amounts of EGR to effectively lower the temperature of combustion and to reduce engine-out NOₓ emissions. I have shown that the addition of alcohol or alcohol/water to diesel fuel has a positive effect on lowering particulate emissions and providing additional engine-out NOₓ reduction. The problem has been to implement this injection approach with a high degree of control and in a cost effective manner. The inventive system is configured to control the feed rates of alcohol, water and primary fuel streams to optimize the proportions for optimal engine-out NOₓ reduction. While alcohol is used generically herein, only methanol and ethanol or mixtures thereof are preferred and ethanol is most preferred.

The instant invention includes the design and application of a water and/or alcohol/water injection system that sprays into the individual cylinder intake ports of a typical diesel or spark ignited engine. The preferred system employs individual electronic injectors for each cylinder intake port and is engine computer controlled to provide a timed, specific quantity injection of the water or water/ethanol mixture. The system allows calibration to minimize engine-out NOₓ emission at any engine operating condition while assuring minimum impact on overall engine performance and fuel efficiency. The control system for the secondary ethanol/water injection system is incorporated in existing engine controllers or as a stand alone computer in the case of a retrofit application of the system. This type of system is applicable to any diesel engine system, new or existing. Additionally, with the incorporation of a fast response NOₓ sensor in the engine exhaust stream, closed loop feedback control of the secondary injection system provides additional precise NOₓ control.

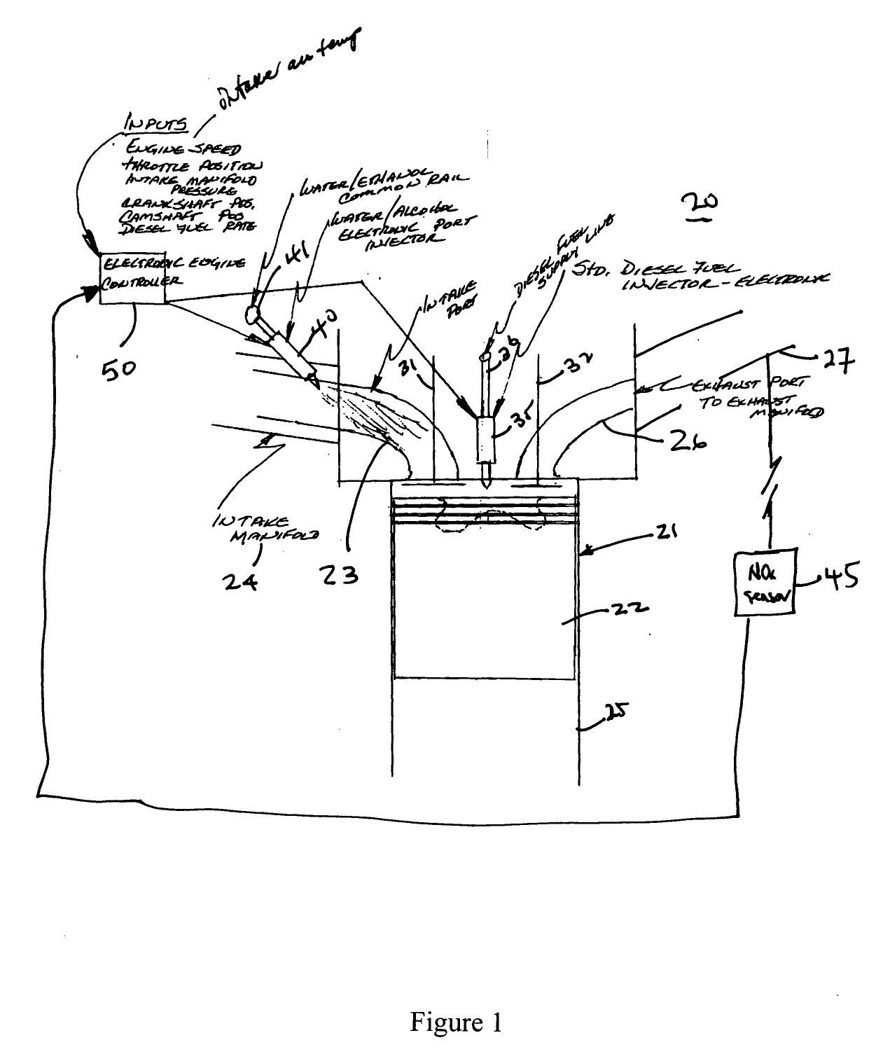

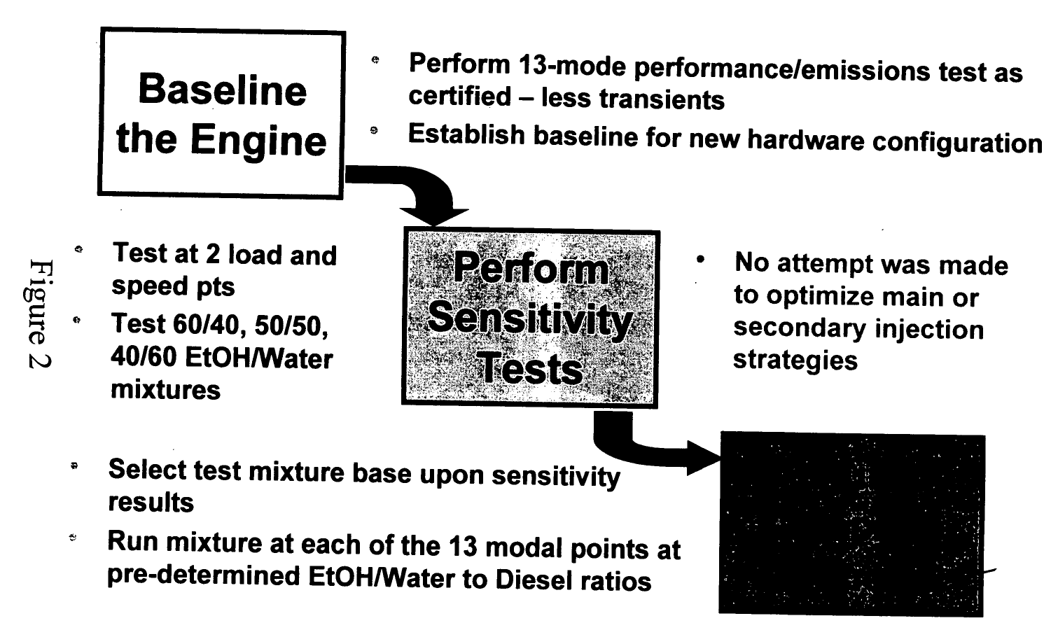

Referring now to FIG. 1, there is shown a schematic representation of a diesel engine 20 having a cylinder 21 including a cylinder wall 25 and a cylinder head 22. An intake port 23 is in communication with the cylinder 21 and in communication with an intake manifold 24; an exhaust port 26 is in communication with the cylinder 21 and an exhaust manifold 27.

The intake port 23 is provided with a intake valve 31 while the exhaust port 26 is provided with an exhaust port valve 32, all as is well known in the art. The diesel fuel injector 35 is in communication with the cylinder 21 and has a supply line 36 connected thereto in communication with a supply of diesel fuel (not shown). A water and alcohol (ethanol and/or methanol) injector 40 is in communication with the intake port 23 and has a supply line 41 in communication with a source of water and/or alcohol mixture (not shown) which may be of the common rail type. Finally, a NOₓ sensor 45 is in communication with the exhaust manifold 27 and is connected, as is seen, electrically to an electronic engine controller 50. The electronic engine controller 50 is of the common and well known type that senses one or more of the engine speed, intake air temperature, throttle position, intake manifold pressure, crank shaft position, cam shaft position, and correspondingly adjust the diesel fuel flow rate. The electronic engine controller 50 is a standard computer which is also connected to the water/alcohol injector to control the ratio of water and alcohol injected as well as the rate at which it is injected, thereby controlling the ratio of ethanol/water to diesel fuel which is facilitated by the electronic communication between the diesel injector 35 and the electric engine controller 50.

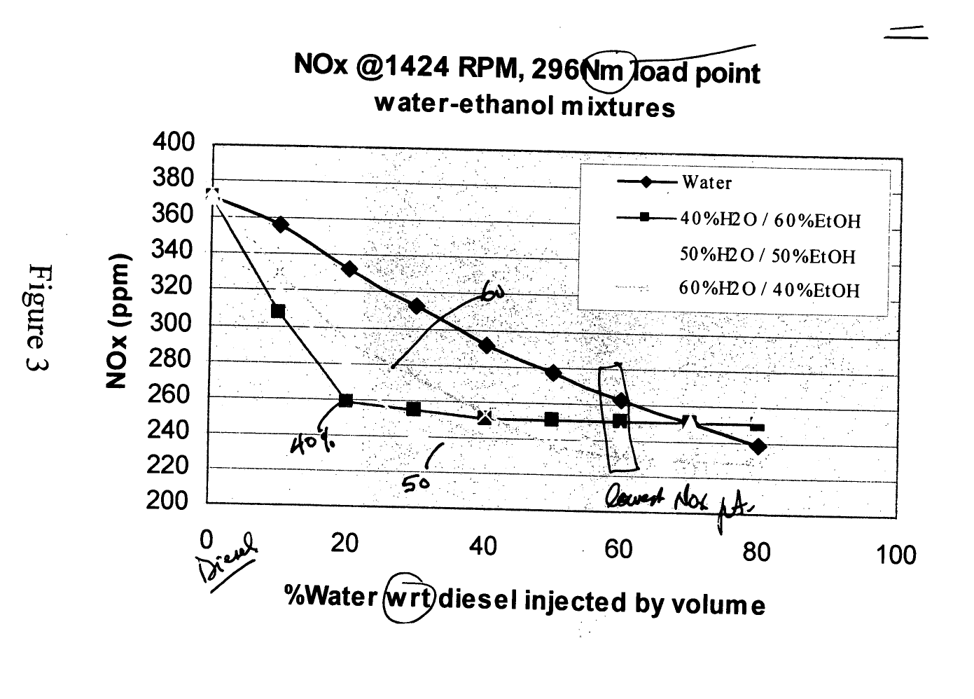

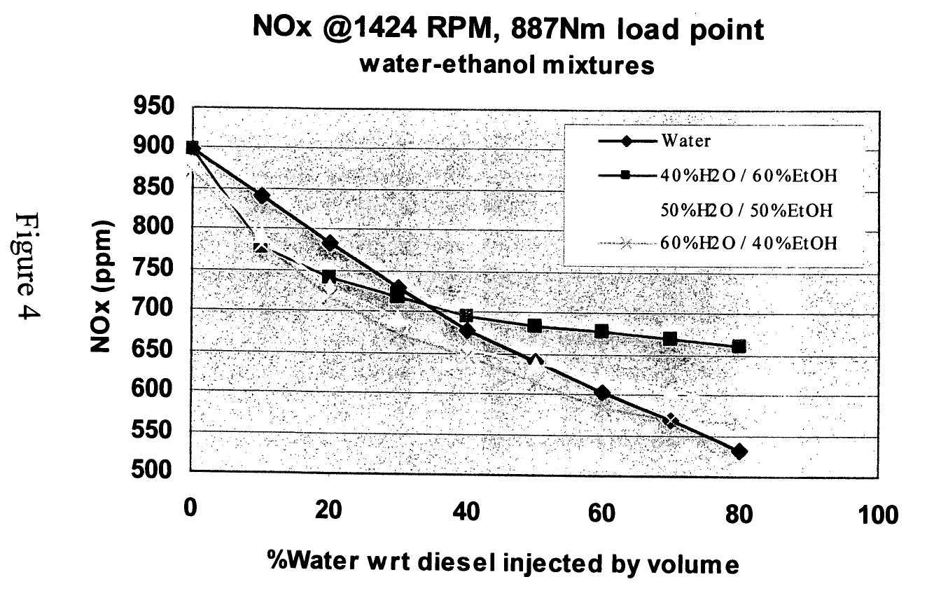

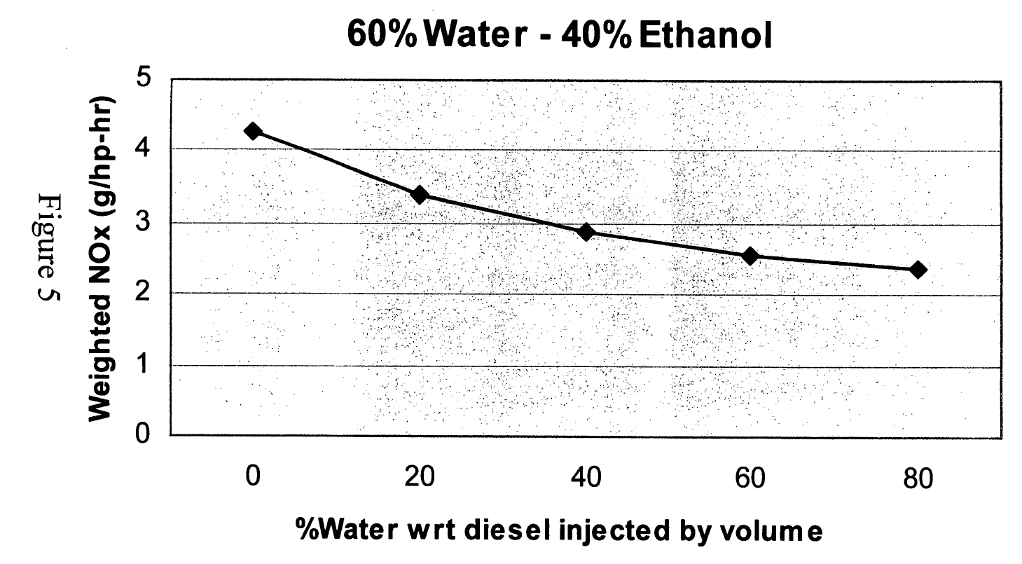

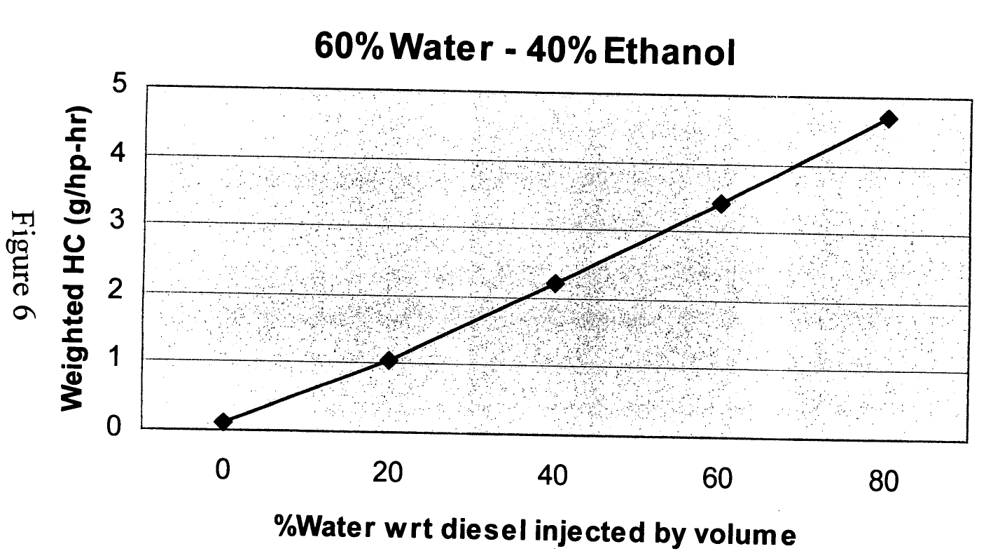

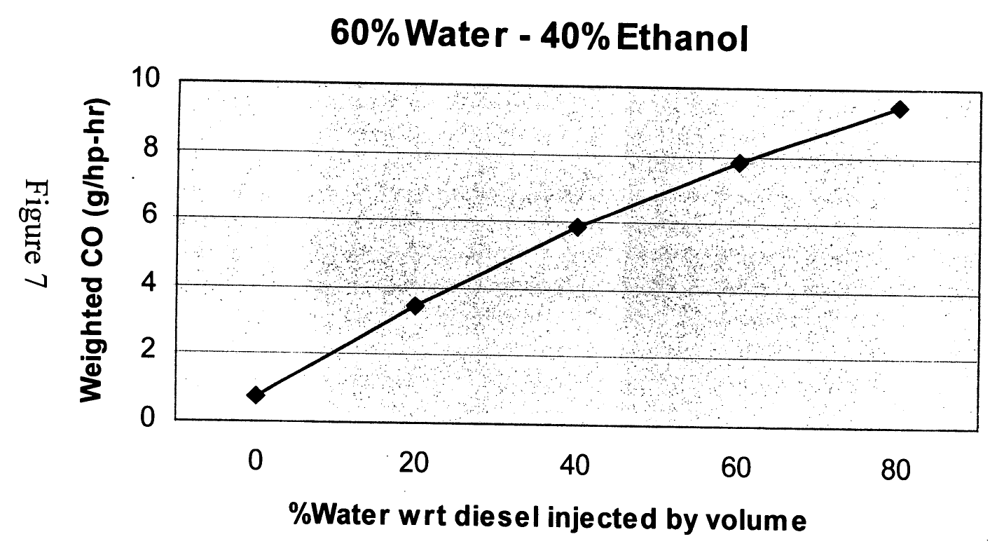

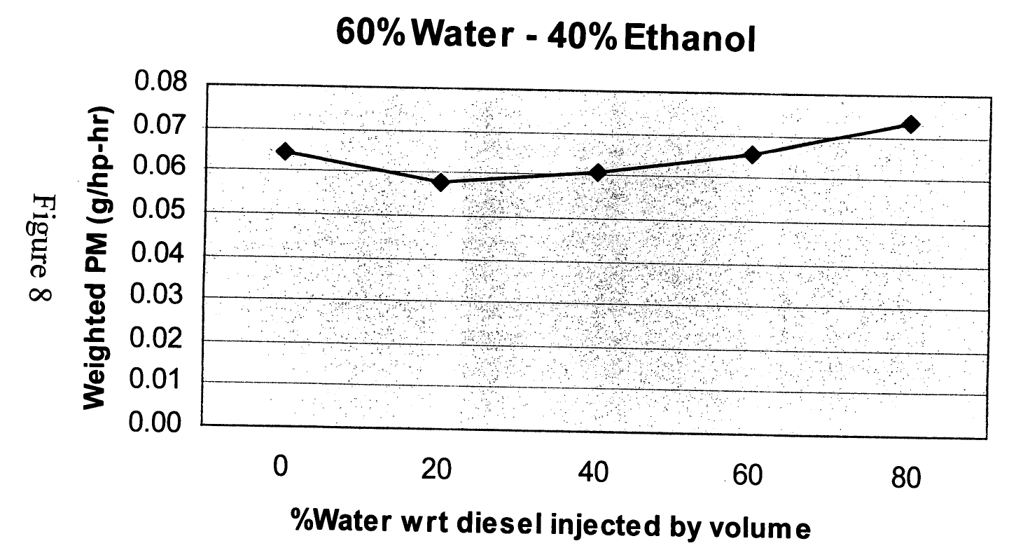

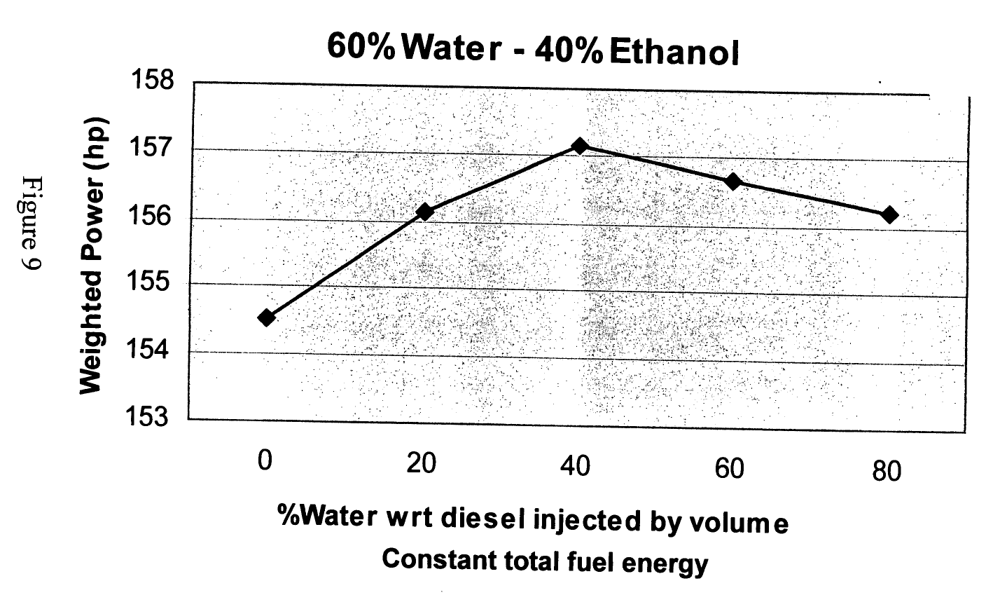

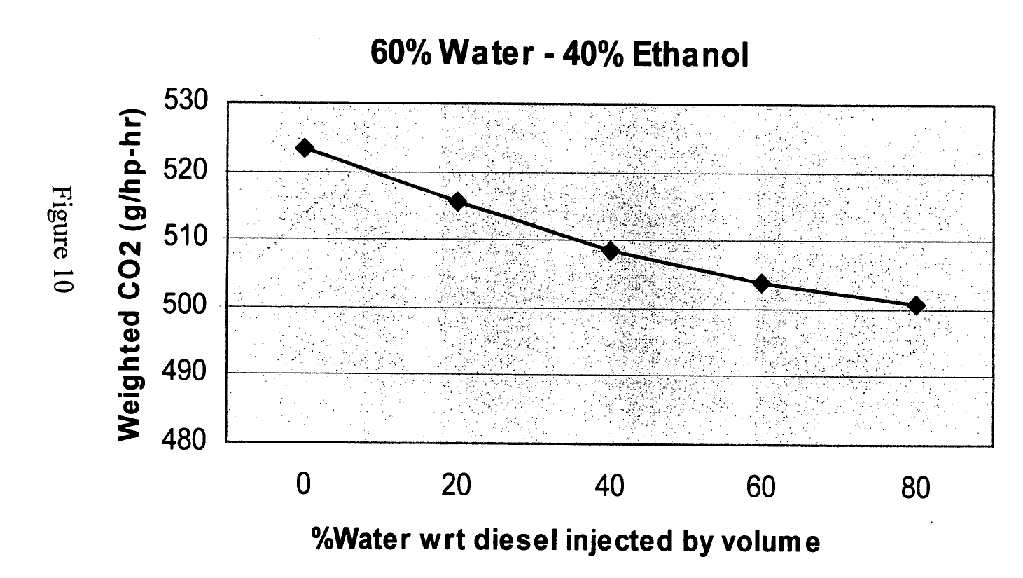

As seen from the enclosed FIGS. 3-10, at low engine load, the alcohol or ethanol component of the mixture is the dominant contributor to NOₓ reduction. As the ethanol/water mixture to diesel ratio is increased, there is a point of diminishing returns on the NOₓ reduction. Particulate matter decreased at high loads and increased at low loads but overall, the particulate matter cycle results held steady. Increased particulate matter is not necessarily a detriment since the particulate matter may be used in remediating the exhaust. Both the hydrocarbons and carbon monoxide increase linearly as the ethanol/water mixture to the diesel fuel ratio and can readily be oxidized by a catalytic converter. Because carbon monoxide is not a greenhouse gas, this poses few problems. Even at high or very high amount of ethanol/water mixture to diesel fuel ratios, the combustion does not break down and results in significant diesel fuel savings or efficiency. As much as 25%. Compared on a equal energy basis, diesel engine efficiency, as measured by diesel fuel use, is improved.

As before stated, this invention is particularly and specifically directed to diesel engines and is useful not only because it reduces NOₓ emissions which are very bad for the environment but reduces the use of diesel fuel. In general, the term alcohol has been used to denote either ethanol or methanol or mixtures thereof, ethanol being preferred since it is a renewable resource and is the subject of certain government programs to increase the use thereof. The device of the present invention is also very useful because it can not only be used with new diesel engines but it is easy to retrofit on existing diesel engines as clearly illustrated by the description of FIG. 1.

In many instances, a NOₓ sensor 45, as previously described, can be used in the exhaust system of diesel engines in order to facilitate and provide rapid response in varying the ratio of water/alcohol ratio to diesel fuel to produce improved results. It is understood that the water/alcohol to diesel fuel ratio will depend in part on engine load and speed as well as particular characteristics of each engine and other factors all of which are disclosed as being sensed by a computer 50 which is used in most diesel engines today.

While the invention has been particularly shown and described with reference to a preferred embodiment hereof, it will be understood by those skilled in the art that several changes in form and detail may be made without departing from the spirit and scope of the invention.

The embodiments of the invention in which an exclusive property or privilege is: claimed are defined as follows:

1. A system for reducing the emissions of the oxides of nitrogen(NOₓ) and improving the fuel efficiency of a diesel engine having at least one combustion chamber and a camshaft and a crankshaft and an intake port and an operator controlled throttle comprising:
a) at least one electronically actuated diesel fuel injector;
b) a diesel fuel supply reservoir communicatively connected with said diesel fuel injector and including diesel fuel pumping means for maintaining diesel fuel pressure at the inlet of said diesel fuel injector;
c) at least one electronically actuated water and/or alcohol injector;
d) a water and/or alcohol supply reservoir communicatively connected with said water and/or alcohol injector and including water and/or alcohol pumping means for maintaining liquid pressure at the inlet of said water and/or alcohol injector; and
e) electronic regulating means for controlling the rate at which atomized diesel fuel and water and/or alcohol are independently injected respectively into said combustion chamber and intake port,
said means being operatively connected to said injectors and being responsive to one or more of air temperature in said air intake manifold, the position of said throttle, the intake manifold pressure, the camshaft position, the crankshaft position, the engine rotational speed wherein the amount of water and/or alcohol injected into said intake port is controlled as a function of both the amount of diesel fuel and alcohol injected and the ratio of diesel fuel and alcohol to air in said combustion fuel mixture to reduce NOₓ emissions and improve fuel efficiency over the operating range of said diesel engine.

2. The system of claim 1, wherein the alcohol is methanol or ethanol or a mixture thereof.

3. The system of claim 2, wherein the alcohol is ethanol.

4. The system of claim 1, wherein the ratio of water to alcohol is in the range of from about 40:60 to about 60:40.

5. The system of claim 4, wherein the ratio of water to alcohol is about 50:50.

6. The system of claim 1, wherein the alcohol is ethanol and the ratio of water to ethanol is about 50:50.

7. The system of claim 1, and further including a NOₓ sensor in communication with the system exhaust and in communication said electronic regulating means to provide information regarding the NOₓ level in the diesel engine exhaust to said electronic regulating means.

8. A method for reducing the emissions of the oxides of nitrogen(NOₓ) and improving the fuel efficiency of a diesel engine having at least one combustion chamber and a camshaft and a crankshaft and an intake port and an operator controlled throttle comprising:
a) providing at least one electronically actuated diesel fuel injector;
b) providing a diesel fuel supply reservoir communicatively connected with said diesel fuel injector and including diesel fuel pumping means for maintaining diesel fuel pressure at the inlet of said diesel fuel injector;
c) providing at least one electronically actuated water and/or alcohol injector;
d) providing a water and/or alcohol supply reservoir communicatively connected with said water and/or alcohol injector and including water and/or alcohol pumping means for maintaining liquid pressure at the inlet of said water and/or alcohol injector; and
e) providing electronic regulating means for controlling the rate at which atomized diesel fuel and water and/or alcohol are independently respectively injected into said combustion chamber and intake port and operatively connected to said injectors and being responsive to one or more of air temperature in said air intake manifold, the position of said throttle, the intake manifold pressure, the camshaft position, the crankshaft position, the engine rotational speed, wherein the amount of water and/or alcohol injected into said intake port is controlled as a function of both the amount of diesel fuel and alcohol injected and the ratio of diesel fuel and alcohol to air in said combustion fuel mixture to reduce NOₓ emissions and improve fuel efficiency over the operating range of said diesel engine.

9. The method of claim 8, wherein the alcohol is methanol and/or ethanol and the ratio of water to alcohol is in the range of from about 40:60 to about 60:40.

10. The method of claim 9, wherein the alcohol is ethanol and the water to ethanol ratio is about 50:50.

11. The method of claim 8, and further providing a NOₓ sensor in communication with the system exhaust and in communication said electronic regulating means to provide information regarding the NOₓ level in the diesel engine exhaust to said electronic regulating means.
